(19) United States
(12) Patent Application Publication
(10) Pub. No.: US 2002/0042700 A1
(43) Pub. Date: Apr. 11, 2002

(54) Method and apparatus for integrating and displaying real-time information related to natural gas pipelines

(76) Inventors: William D. Giles, Houston, TX (US); Mark E. MacPherson, Woodlands, TX (US)

Correspondence Address: Vinson & Elkins L.L.P., 2300 First City Tower, 1001 Fannin Street, Houston, TX, 77002-6760, US

(21) Appl. No.: 09/917,003

(22) Filed: Jul. 27, 2001

Related U.S. Application Data
(60) Provisional application No. 60/229,703, filed on Aug. 31, 2000.

(51) Int. Cl. G06G 7/48

(52) U.S. Cl. 703/6

(57) ABSTRACT

The present invention is a method and apparatus for integrating and displaying information related to a natural gas pipeline. When characterized as a method, the present invention initially obtains commercial, operational, and modeling information about the natural gas pipeline. Next, the commercial information is related to the operational information. Afterwards, the various types of information are associated with a location on a geographic representation of the natural gas pipeline so that users can visualize from where on the pipeline the information is originating. Finally, the information, and the “map” of the pipeline are displayed together. When characterized as an apparatus, the present invention uses a computer system to collect and store the commercial, operational, and modeling information about the natural gas pipeline. The computer system then executes software to relate the commercial information to the operational information. Next, the information is associated with a location on a map of the pipeline. Lastly, the computer system displays the information along with a map of the pipeline.

### REFERENCE TO EARLIER FILED APPLICATION

This application claims the benefit of U.S. Provisional Application No. 60/229,703, filed Aug. 31, 2000.

### BACKGROUND OF THE INVENTION

1. Technical Field

The present invention relates generally to a computer system for integrating and displaying information related to natural gas pipelines. Specifically, the present invention gathers a variety of information related to delivering natural gas into a pipeline, transporting the gas through the pipeline, and withdrawing the gas from the pipeline. This information is then graphically presented so that a natural gas pipeline can be better managed and operated more efficiently.

2. Description of the Related Art

The operation of a natural gas pipeline generates immense amounts of information. This information includes operational and commercial data related to delivering gas into the pipeline, transporting gas through the pipeline, and withdrawing gas from the pipeline. While all of this information has traditionally been available to gas transmission companies, the form in which the information has typically been presented did not allow for the efficient or timely use of the information. Often times, commercial information related to a gas transmission company's contractual obligations to transport and deliver gas for its customers is kept in one technical format in one location, while operational information related to the performance of the pipeline is kept in another format apart from the commercial information.

A common scenario in which the disconnect between commercial information and operational information becomes apparent involves contracts for the delivery of gas to specific commercial customers and the ability of the pipeline to supply gas to those customers and others located along the same segment of the pipeline. In the past, information generated by demand forecasting models and sales information related to commitments made by the company's sales agents have been difficult to bring together so that informed and timely decisions can be made with respect to the operation of the pipeline. Without knowing all of the relevant information related to the projected demand for the gas, gas transmission companies had to constantly operate their pipelines under a “worse case” scenario with respect to the potential demand for their gas. Operating in such a manner is inefficient because more resources than necessary have to be committed to transportation and delivering gas. If gas transmission companies know with some certainty the amount of gas that will be needed in the following hours and days, the companies can take steps to ensure that there will be enough gas for everyone, without committing too many resources to supply the gas.

### SUMMARY OF THE INVENTION

Generally, the present invention is a method and apparatus for integrating and displaying information related to a natural gas pipeline using a computer system. When characterized as a method, the present invention initially obtains commercial, operational, and modeling information about the natural gas pipeline. Next, the commercial information is related to the operational information. Afterwards, the various types of information are associated with a location on a geographic representation of the natural gas pipeline so that users can visualize from where on the pipeline the information is originating. Finally, the information, and the “map” of the pipeline are displayed together.

When characterized as an apparatus, the present invention uses a computer system to collect and store the commercial, operational, and modeling information about the natural gas pipeline. The computer system then executes software to relate the commercial information to the operational information. Next, the information is associated with a location on a map of the pipeline. Lastly, the computer system displays the information along with a map of the pipeline.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a communications network and a series of computers upon which the present invention can be implemented;

FIG. 2 is a flowchart that depicts a method by which the present invention operates;

FIG. 3 depicts a menu from which a series of maps and charts can be selected;

FIG. 4 illustrates a screen that shows the available capacity at key points in the pipeline, the amount of gas scheduled by the customers to be delivered and withdrawn from the pipeline for a given day, as well as the amount of gas predicted to be delivered and withdrawn by modeling systems;

FIG. 5 illustrates a screen that shows information representing the actual volume of gas that flowed through a section of the pipeline during the previous five days, as well as the forecast and scheduled volume of gas to flow through the same section in the next five days;

FIG. 6 depicts a screen that illustrates a particular section of the pipeline shown in FIG. 4 in more detail;

FIG. 7 depicts a screen that contains a bar chart that contains information similar to that presented in FIGS. 4 or 6;

FIG. 8 presents a screen that shows the flow of gas through various sections of the pipeline based upon the level of transmission service for which the customer has contracted;

FIG. 9 depicts a screen that illustrates the “line pack” for a portion of a gas pipeline;

FIG. 10 illustrates a screen that shows the line pack values for a particular section of the pipeline over a 10 day period;

FIG. 11 illustrates a screen that shows in which sections of the pipeline imbalances are occurring;

FIG. 12 shows a screen that displays customer information related to the pipeline information shown in the screen illustrated in FIG. 11;

FIG. 13 illustrates a screen that shows the subscribed capacity for various sections of the pipeline;

FIG. 14 depicts a screen that shows the capacity and nominations for major sections of the pipeline; and

FIG. 15 shows a screen that illustrates various imbalances for specific regions of the pipeline.

### DETAILED DESCRIPTION OF THE INVENTION

Generally, the present invention is a computer system that acquires and displays a variety of different types of information related to the production, transportation, and marketing of natural gas. The present invention acquires data from a variety of sources. First, operational information about the pipeline transporting the gas, as well as about the gas itself, is sent to the computer system by various sensors and meters located along the length of the pipeline. The computer system also acquires information about nominations scheduled by various customers, as well as pricing information associated with these nominations. Additional information relating to the forecast supply and demand for gas is additionally accumulated by the computer system. After this information is obtained, accessed, and processed, the computer system presents detailed reports and screens that integrate the different types of information. These reports and screens are useful because they allow the pipeline to be better managed and operated more efficiently.

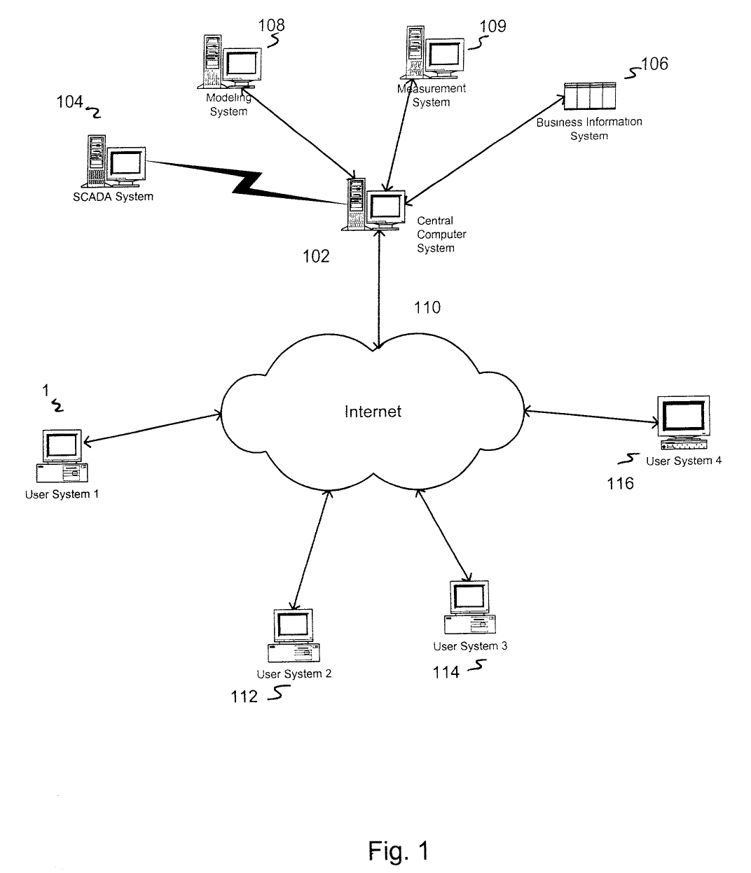

FIG. 1 illustrates a computer system that operates according to the present invention. Central computer system 102 can be comprised of any number of processing and storage units, depending upon the amount of information to be processed. For instance, a large gas transmission company with thousands of miles of pipeline and many customers may need a mainframe computer with a large storage subsystem to properly process all of the data related to its gas operations. On the other hand, a smaller gas transmission company may be able to process all of its data on a smaller computer system. Ultimately, central computer system 102 must be able to process all of a gas transmission company's data as described below.

SCADA (Supervisory Control and Data Acquisition) system 104 obtains and transmits information related to the physical properties of the gas pipeline. Typically, this system is distributed over the entire length of the gas pipeline, and consists of various sensors, meters, and monitoring units that measure such variables as pressures, flow accumulation (both decatherms and mcf), flow rates, gas temperatures, ambient temperatures, meter configurations, gas quality, equipment statuses, alarms, etc. The manner in which this information is obtained and transmitted to a central computer system is know in the art. The information measured and transmitted to central computer system 102 by SCADA system 104, and any other data that can be measured or discerned that relates to a physical characteristic of the pipeline, are hereinafter referred to as “operational information.”

Measurement system 109 collects information relating to the delivery and removal of gas from the pipeline. Many measurement devices are located along the pipeline. These measurement devices collect data from individual meters about the gas delivered to and withdrawn from the pipeline. These measurement devices relay this information to other devices, which, in turn, finally send all of the accumulated information to measurement system 109. For the purposes of the present invention, the data collected by measurement system 109 is considered to be “operational information.”

Business information system 106 contains information related to the business arrangements between the gas transmission company and its customers. Examples of such information include how much gas a specific customer is scheduled to transport over a certain period of time and the price of transporting the gas. Business information can be extracted from written contracts and manually entered into business information system 106, or, such information can be extracted from the gas transmission company's commercial and accounting systems. Business information system 106 is normally comprised of many computer systems that have been networked together or a mainframe computer. Typically, business information systems, like business information system 106, utilize special software to manage the information they contain. Such software can be developed by the gas transmission company or purchased from a third party software vendor. Examples of commercially available software include DB2, Oracle, and Sybase. Business information system 106 also contains information related to the financial terms under which customers have agreed to transport gas on the pipeline. The commercial information stored and managed by business information system 106, and any other financial information related to the pipeline, are herein referred to as “commercial information.”

Modeling system 108 executes software that predicts the future supply and demand for gas at every receipt and delivery point on the pipeline. Generally, gas consumption can be predicted based upon weather forecasts, knowledge of customer's previous consumption patterns of gas, future commitments to supply gas, economic factors and other indicators known in the art. Gas supplies can be predicted based upon knowledge of supplier's previous patters of supply, future obligations to take gas from suppliers, and other indicators known in the art. Also, modeling system 108 can analyze the pipline's future ability to transport the gas from one point to another. Modeling system 108 accounts for factors such as the availability of compressor stations and compressor units, the utilized capacity of these stations and units to move gas through the pipeline, the flow of gas through certain segments of the pipeline being restricted, new equipment becoming operational, and the like, in determining the pipline's ability to move gas from one point to another. The information related to future gas supply and demand developed by modeling system 108, and any other predictive information related to future activities involving the pipeline, are hereinafter referred to as “modeling information.” Collectively, the operational, commercial, and modeling information is referred to herein as “integrated gas information.”

SCADA system 104, business information system 106, modeling system 108, and measurement system 109 can be connected to central computer system 102 by any one of a number of methods as known in the art. Some examples by which these computer systems can be connected together include local area networks, wide area networks, intranets, the Internet, and other such methods.

Central computer system 102 is further connected to network 110. As shown in FIG. 1, network 110 can be the Internet, or network 110 can be a wide area network, a local area network, an intranet, or some combination thereof. Attached to network 110 are user systems 111-116. These users are able to interact with central computer system 102 via network 110. User systems 111-116 can be comprised of personal computers or workstations running under the control of an operating system that provides for a graphical user interface, such as one of the various versions of the Windows operating system by Microsoft Corporation.

FIG. 1 is but one possible embodiment of a computer system that can implement the present invention. In the future, the functionality described with respect to the various individual components of the computer system shown in FIG. 1 may be able to be implemented on fewer individual systems than are shown in FIG. 1. At some point, a single computing device may be able to replace those shown in FIG. 1. Thus, it is the operation of the computer system shown in FIG. 1 that is of primary importance, not the particular arrangement of devices shown.

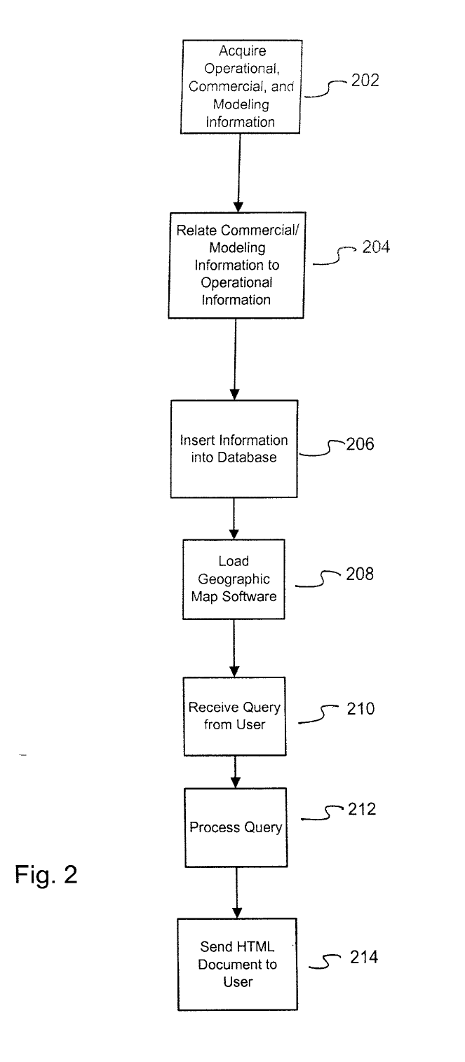

FIG. 2 is a flowchart that illustrates a method by which the present invention operates. Initially, the integrated gas information is either acquired by or made available to the central computer system (202). Operational information relating to the gas pipeline is provided to the central computer system by various SCADA system. Commercial information relating to various customers' anticipated transmission needs and the price for transporting the gas is also supplied to the central computer system. This information is normally supplied by other computer systems that manage the gas transmission company's commercial matters. In addition, modeling information is supplied to the central computer system by the modeling systems that predict the anticipated supply and demand for gas as well as the operational capabilities for the pipeline.

After access to the integrated gas information is secured, the commercial information is related to the operational information (204). Relating the commercial data to the operational data involves relating the way in which a customer has nominated for transporting gas on the pipeline to the actual, physical manner in which gas is withdrawn from or supplied to the pipeline. This process of determining the nomination amount for every physical point is referred to as “physicalizing the nominations.” The term “nominations” refers to the customer's planned delivery to or withdrawal of gas from the pipeline. While a customer may nominate at a physical or accounting nomination point, gas is supplied to or withdrawn from the pipeline at a physical measurement point. The amount of gas supplied or withdrawn for each physicallized nomination point can be compared against the volumes measured at a physical meter to identify imbalances and other potential issues.

Nominations must be related to the operational data because a customer's nominations often do not reflect the actual manner in which gas is being withdrawn from or supplied to the pipeline. For example, a customer can request to withdraw or supply gas at an “accounting” meter. An accounting meter is a fictional meter that is created for the benefit of the customer, usually to simplify the customer's accounting or bookkeeping procedures. In reality, gas withdrawn or supplied at this fictional accounting meter may actually be withdrawn or supplied at several actual, physical meters. Thus, to accurately display what is physically happening to the pipeline, commercial data that is expressed in terms of accounting meters must be related to the actual manner in which gas is really being withdrawn or supplied.

Likewise, a customer may request to deliver or withdraw gas at a single physical meter, but may actually deliver or withdraw the gas through several physical meters. Again, this “fictional” commercial information must be reconciled with the way the customer is actually delivering or withdrawing gas from the pipeline.

The first step in the process of relating the commercial information to the physical information is to transform the units of time associated with the commercial information into the same units of time in which the operational information is measured. For instance, if the operational information is being measured in volume per hour and the commercial information is expressed in volume per day, the commercial information will be broken down into hour time frames to match the operational information.

Next, the commercial information is translated into the physical realm. Thus, if a customer's nominations are expressed in terms of an accounting meter, the actual, physical meters associated with that accounting meter are identified. For example, assume a customer has nominated to take 10 units of gas at accounting meter A, and the gas will actually be withdrawn from physical meters B, C, and D. The process of translating the commercial information into actual, physical information will search the gas transmission company's records to identify the physical meters associated with the accounting meter. Then the process translates the commercial information into operational information. In the example presented above, the process would identify meters B, C, and D as being associated with accounting meter A, then, the process would assign the appropriate volume to each meter based upon the load predicted at the individual meters as well as any other information that should be considered.

After the commercial information is related to the operational information, the data mentioned above is delivered into a database structure (206). In a preferred embodiment of the present invention, a relational database program such as Sybase is utilized. A database structure is used to store the various information because it allows the information to be more easily processed and retrieved by other programs.

Some of the information inserted into the database has been preprocessed. The processes described in steps 202 and 204 are computationally intensive. Thus, to provide an appropriate level of response to a user query for the information (as will be described below), many commonly requested combinations of data are computed before being stored in the database. In one embodiment, the processes described in steps 202 and 204 execute almost continually, and update the database with new information every hour, or faster if the processing resources exist. This allows for the preprocessed data to be extracted from the database quickly, and presented to the user in a short period of time.

Either before or after the integrated gas information is obtained and loaded into a database on the central computer system, geographic maps are also loaded onto the central computer system as static images (208). Mapping software is also loaded on to the central computer system. This mapping software is used in conjunction with the information described in steps 202 and 204 to dynamically display integrated gas information on to the static images based on the latitude and longitude of the geographic location from which the information originated. The static map image also shows a geographic representation of the gas pipeline along with the integrated gas information. As is shown in some of the figures discussed below, the static map images also illustrate the various states and towns through which a given gas pipeline runs. Graphically displaying such information gives a geographic perspective from which to view the information for the pipeline. The mapping software also manages the level of detail available at a given scale. For example, if a user chooses to view the entire eastern United States, the mapping software will only present the major features of the gas pipeline, along with a summarized level of information that is available for the entire pipeline. The mapping software operates in this manner to ensure that the displayed information is legible and can be easily discerned. On the other hand, if a user chooses to view a relatively small section of the pipeline, the mapping software will allow for more information to be displayed about the particular section of the pipeline than was displayed for that section of the pipeline in a more expanded view. The particular amount of information displayed at a given scale can be varied according to a administrator's preferences.

After the central computer systems processes all of the integrated gas information, the appropriate static map images are obtained, and the mapping software is stored and properly configured, the central computer system receives and processes queries from a user (210). Generally, these queries are requests for the central computer system to display some combination of integrated gas information in conjunction with the mapping software. Also, a query can request the central computer to display some combination of the integrated gas information in the form of a chart or graph, without accessing the mapping software. In a preferred embodiment of the present invention, a user forms a query by selecting certain options from a menu presented to the user. Further, in this preferred embodiment, the user interacts with the central computer system through a commercially available web browser, such as Microsoft's Internet Explorer.

The query specifies the types of information the user wishes to view, as well as the format in which the user wishes to view the information. A user can choose to view any logical combination of the integrated gas information that was inserted into the database in step 206. In a preferred embodiment of the present invention, certain predefined combinations of information are presented to the user for selection. The user then forms a query by selecting one of the predefined sets of information for viewing. The user can also specify that the information be displayed in a geographic or tabular format.

Once a query has been formed by the user and transmitted to the central computer system, the central computer system processes the query (212). In processing the query, the central computer system retrieves the information specified in the query and formats it as specified, possibly accessing the mapping software to display the information in the geographic location it originated. Then, the central computer system creates an HTML document and transmits it back to the user's computer system (214). Using the web browser located on the user's computer system, the user will then be able to view the information and make decisions regarding the management and the operation of the pipeline, as well as additional commercial opportunities.

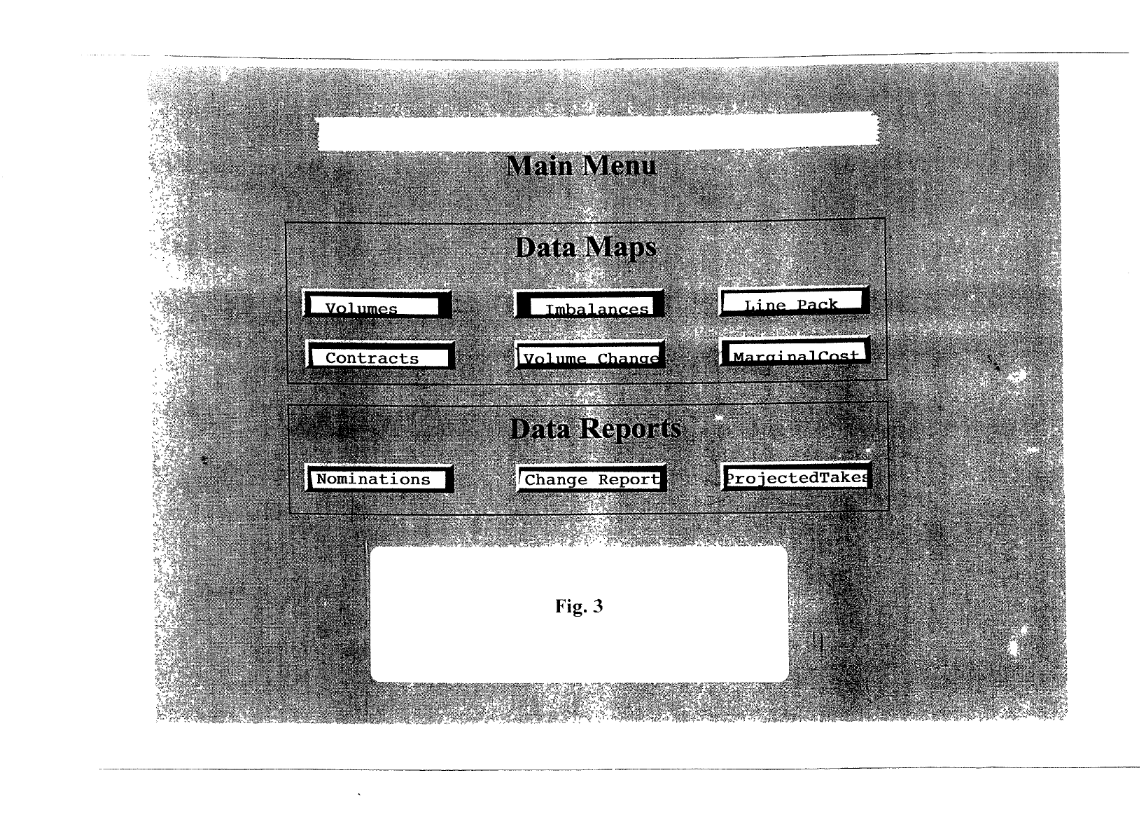

FIG. 3 depicts a high-level menu from which a series of maps and charts can be selected. The charts available from this screen illustrate various combinations of information related to a gas pipeline and are generated in accordance with the method described above. The screens available for selection from the menu shown in FIG. 3 are described below.

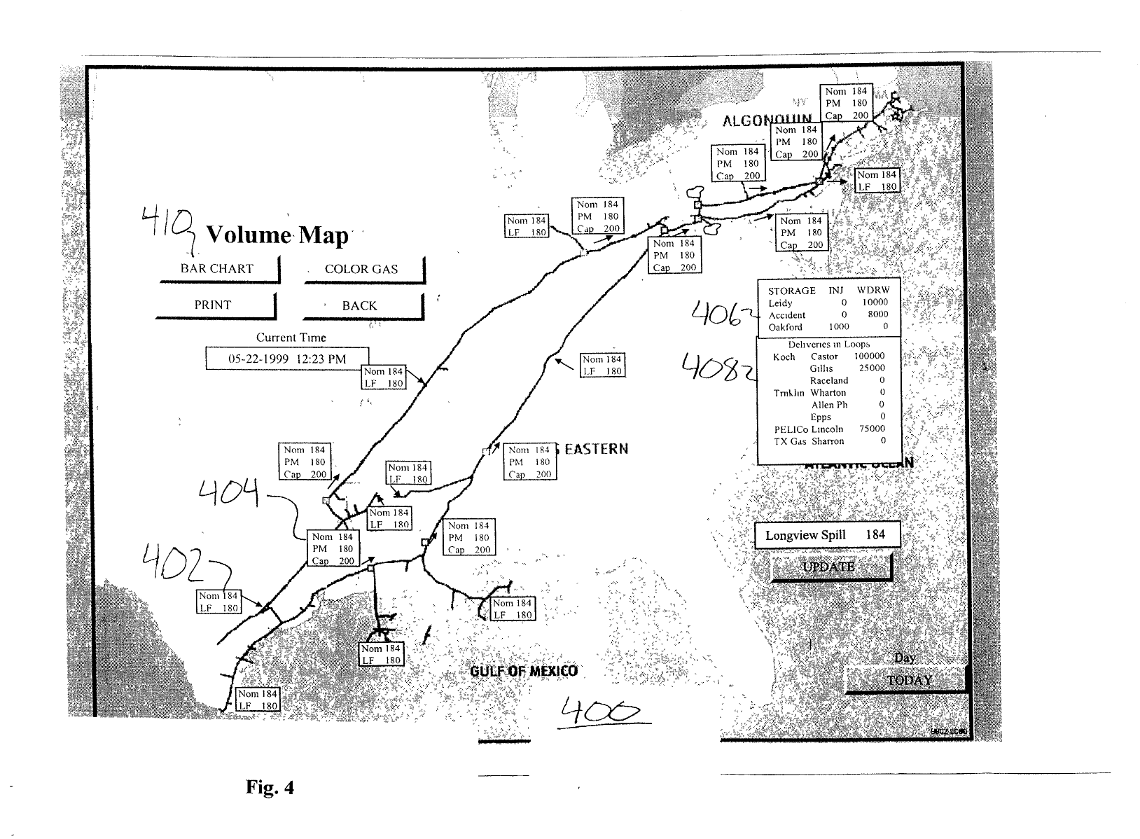

FIG. 4 illustrates a screen that shows the amount of gas scheduled by the customers to be delivered and withdrawn from the pipeline for a given day, as well as the amount of gas predicted to be delivered and withdrawn by the modeling systems. The volume map is used to view the nominations and load forecast data and the resulting impact on system throughput.

In FIG. 4, information related to the volume of gas being transported through the pipeline is presented for all major inlets and outlets on the pipeline. For customer inlet points, such the location associated with box 402, this information is presented as two values, with one being labeled “Nom” and the other labeled “LF.” The “Nom” (nomination) value is the sum of the scheduled volumes entering and exiting the system at that point. The “LF” (load forecast) value is the sum of the volumes for the same point as predicted by modeling systems. When available, actual volumes are used to update the load forecast/predicted volumes.

For other points of the pipeline, additional information is presented beside the nomination values. For example, the volume of gas flowing through a particular section of the line as well as the capacity of the line are shown for the location associated with box 404, in addition to the nomination values. The nomination values are generated by summing the scheduled receipts and deliveries of gas, starting at the south Texas end of the pipeline to the labeled point, in order to calculate the volume that must be transported through the pipeline at that section. Calculating the throughput in this way carries the assumption that the line pack is not changing over the course of the day. The predictive model (“PM”) values represent the volume of gas predicted by the models to flow through a given section of pipeline. These values are determined by summing (1) the flow through that section integrated from the beginning of the gas day to the present time as reported by the various SCADA systems that measure the flow of gas through that section, and (2) the integration of the flow at that section, as taken from the modeling information, from the present time to the end of the day. The capacity (“Cap”) values represent the maximum capacity of the line at a particular point, at a particular time. The baseline capacity values for line segments are stored along with the other operational information. These baseline values can be altered, however, due to the status of equipment along that segment of the pipeline, as reported by the SCADA systems. All values representing the volume of gas in FIG. 4, as well as the other figures discussed below, represent thousands of cubic feet of gas per day.

Data boxes 406 and 408 on the right side of screen 400 display the volumes of gas sent to and from gas storage facilities, and the volumes of gas to be transported on other pipelines, respectively.

By default, screen 400 presents volume information for the present day. However, if a user wants to view how the scheduled or load forecasted volumes are changing in time, two options are available. First, a user can click on the button labeled “DAY,” located in the bottom, right-hand portion of screen 400. Activating this button will cause the computer system to present a screen that shows the same area previously displayed, but with gas volumes for the next gas day. Scheduled gas volumes for the next day are determined by examining commercial information to determine the gas transmission company's obligations to supply gas to its various customers, and by forecasting the amount of gas to be delivered into the pipeline. The actual amount of gas to flow through a given section of the pipeline is determined by examining the modeling information.

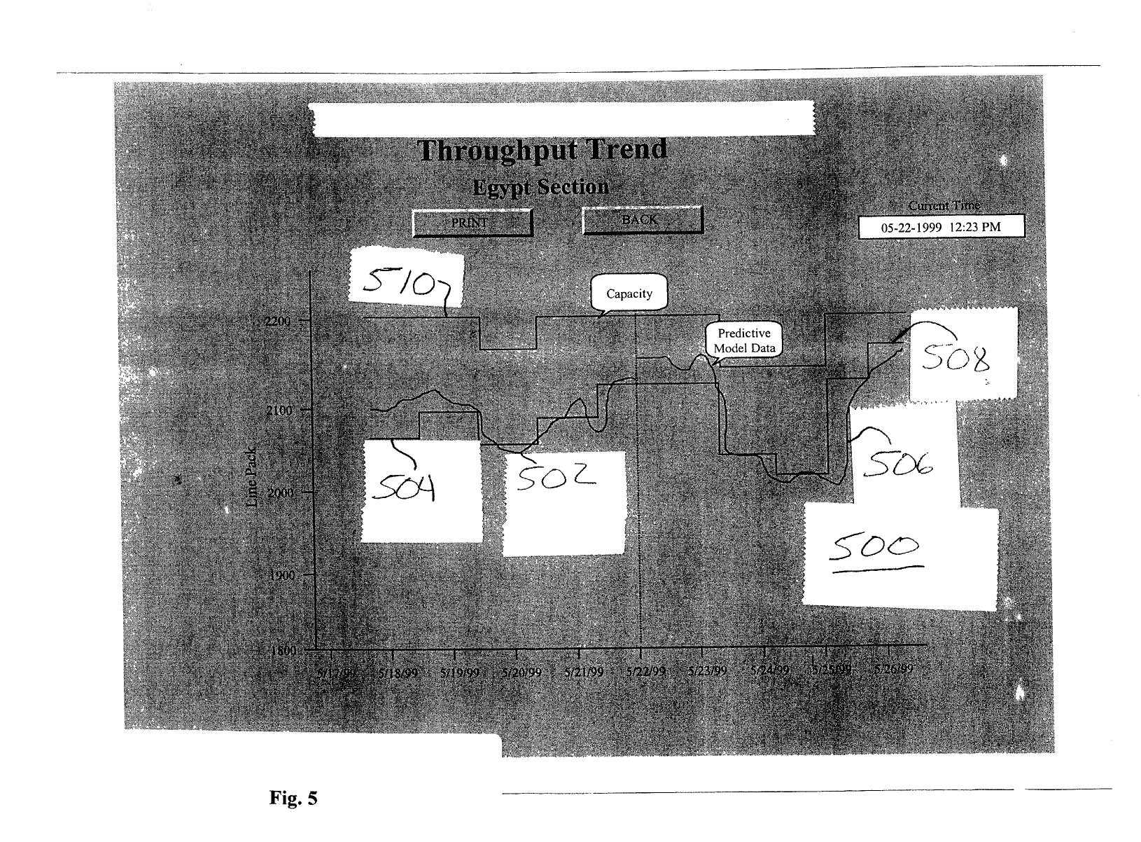

Second, if more detail is required for the throughput at a specific section of the pipeline, a user may click on the data box for that location and a trend of the volumes will be displayed showing the past five days and five days into the future. Upon clicking on a specific data box (e.g., box 404), a screen such as screen 500, shown in FIG. 5, will be presented. Screen 500 illustrates information representing the actual and scheduled volumes of gas that flowed through a section of the pipeline during the previous five days (lines 502 and 504, respectively), as well as the forecast and scheduled volume of gas to flow through the same section in the next five days (lines 506 and 508, respectively). The operational capacity of the pipeline is also displayed for this ten day period (line 510). The information for line 502 comes from the various SCADA and other operational systems located at the point on the pipeline. Lines 504 and 508 are formed with the commercial information for customers upstream of the section under study, as well as the suppliers downstream of the point. Line 506 is derived from modeling information. Thus, screen 500 contains historical and projected traces of the throughput for the section of interest along with the capacity of that section of the pipeline, and the throughput for that section as derived by the scheduled nominations information.

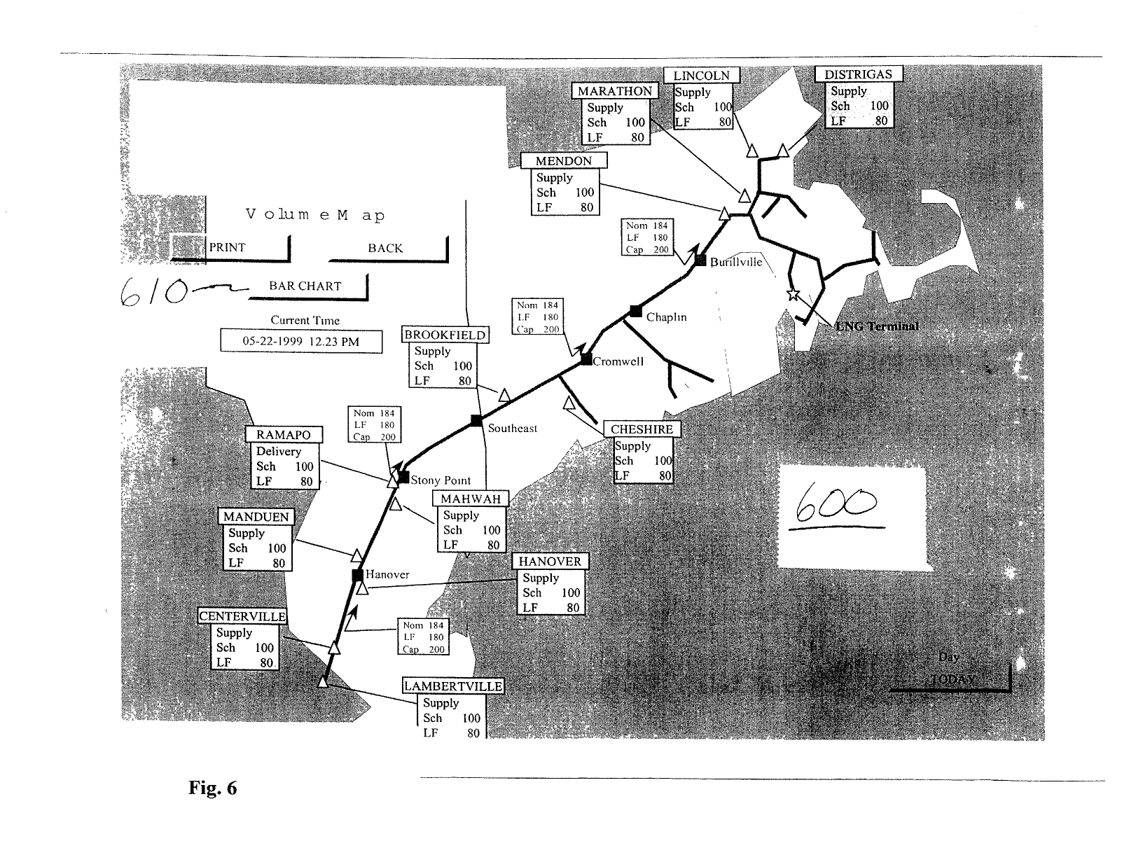

A user can enlarge a given pipeline segment shown in screen 400 by clicking the button of a mouse while the cursor is positioned over the pipeline segment of interest. FIG. 6 is an example of a screen that will be displayed if a user wants to view a portion of screen 400 at a smaller scale. Screen 600 is an enlarged view of the northeastern US compared to what was shown in screen 400. As mentioned above, screen 600 is generated by clicking a mouse button while the cursor is located over the northeastern US, as shown in screen 400. Due to the relatively small geographic area depicted in screen 600 (as compared to screen 400), screen 600 can present more information about the volume of gas flowing through the pipeline in the northeastern US than screen 400 can. The mapping software, discussed above, manages the display of information at a given scale, and, due to the relatively small scale shown in screen 600, the mapping software displays more information for the area shown in screen 600, as compared to screen 400. All of the screens discussed below which display geographic representations of certain portions of the US operate in a similar fashion with respect to their ability to enlarge geographic regions of interest.

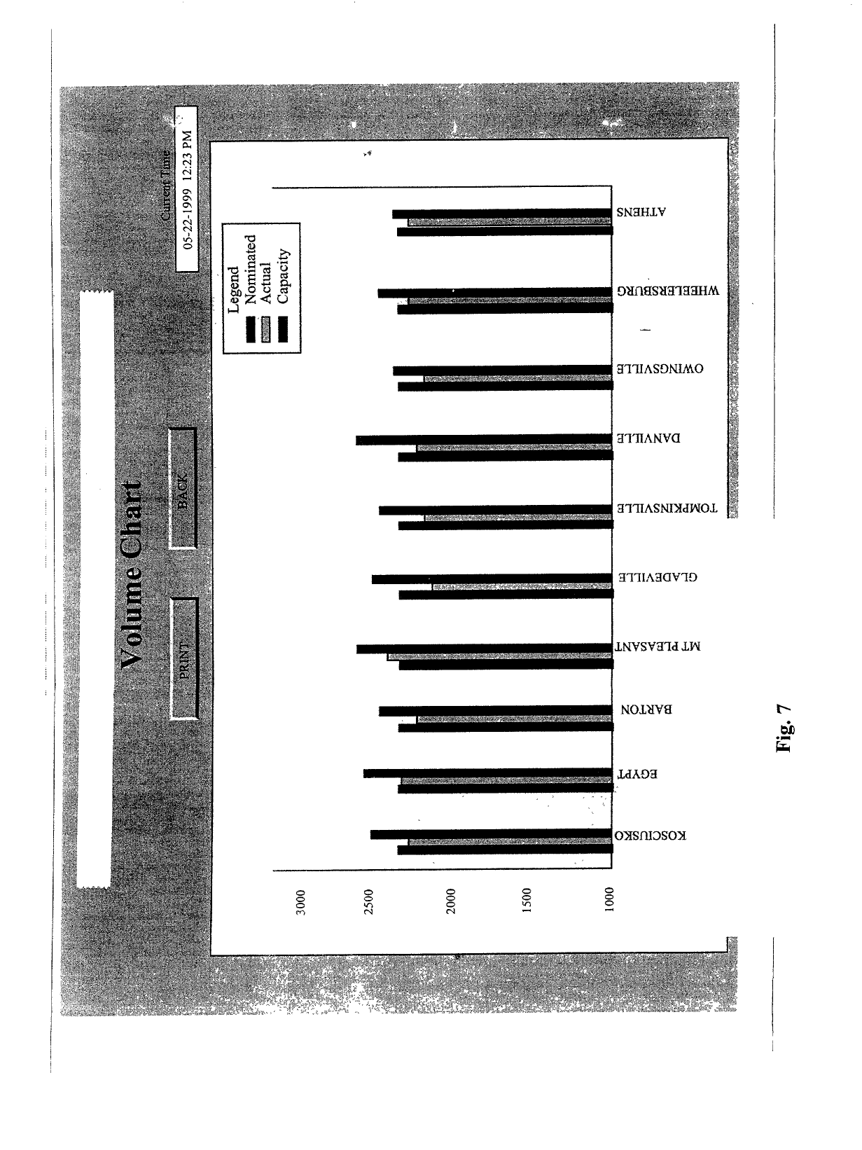

From either screen 400 or 600, a user can choose to view the information shown therein in the form of a bar graph by activating the button labeled “BAR CHART,” shown as button 410 in screen 400 and button 610 in screen 600. FIG. 7 depicts a bar chart than can be generated by selecting the “BAR CHART” button from a screen such as 400 or 600.

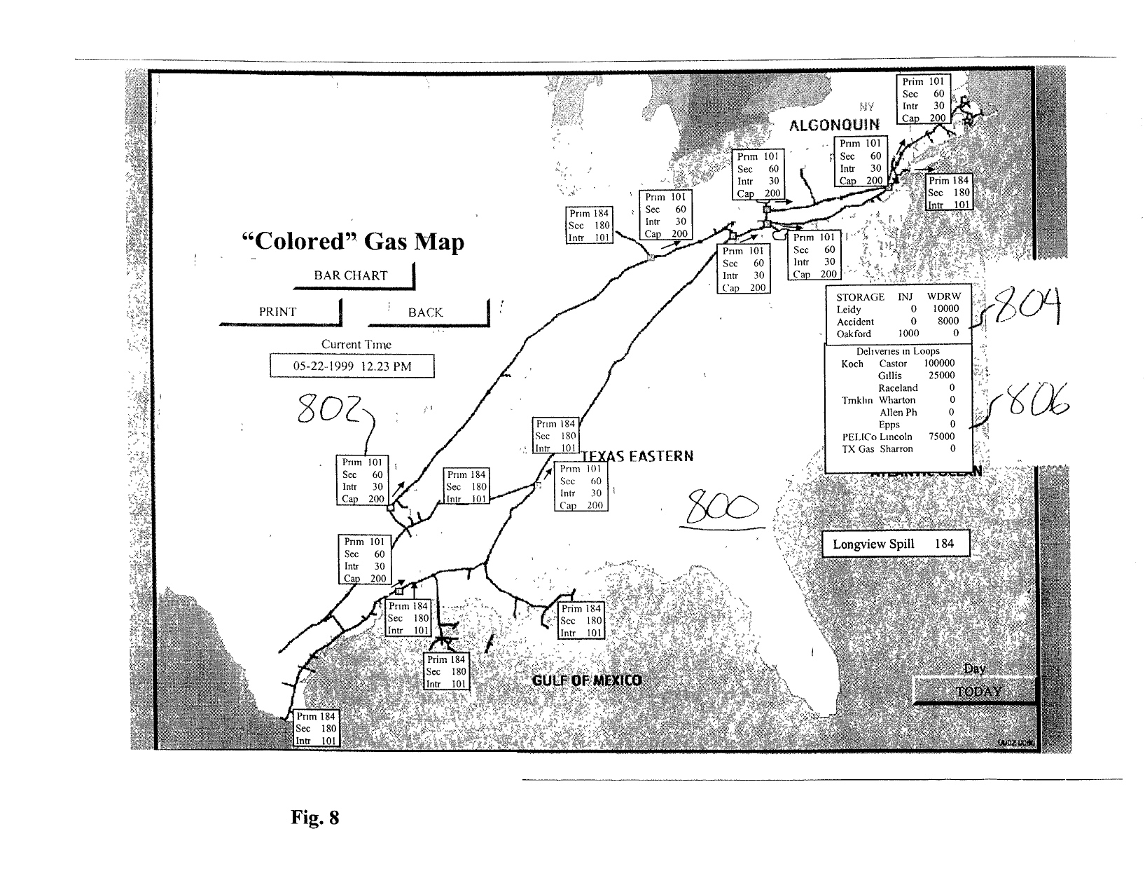

FIG. 8 depicts a screen that shows the flow of gas through a section of the pipeline based upon the level of transportation service for which the customers have contracted. At each supply and delivery point, the gas entering or leaving the pipeline is denoted as being “primary firm,” “secondary firm,” or “interruptible.” This information is displayed in a box next to the section of the pipeline where the information was obtained (e.g., box 802). As is known in the industry, gas sold as “primary firm” means that the scheduled gas will not be reduced unless all “secondary” and “interruptible” gas service has been discontinued. “Secondary firm” means that the scheduled gas will not be cut unless all “interruptible” service has been discontinued. Finally, “interruptible” gas service can be cut at the discretion of the gas transmission company. This information is obtained from the commercial information that contain the terms of the transaction between the gas transmission company and the shipper.

As was the case in screen 400, clicking a mouse button while the cursor is located on a particular segment of the pipeline will display a more detailed view of that pipeline segment that also shows the volumes of gas by contract type for key points in the smaller scale view. In addition, like screen 400, boxes 804 and 806 summarize the volumes of gas being sent to and from gas storage facilities, and the volume of gas to be transported on other pipelines, respectively.

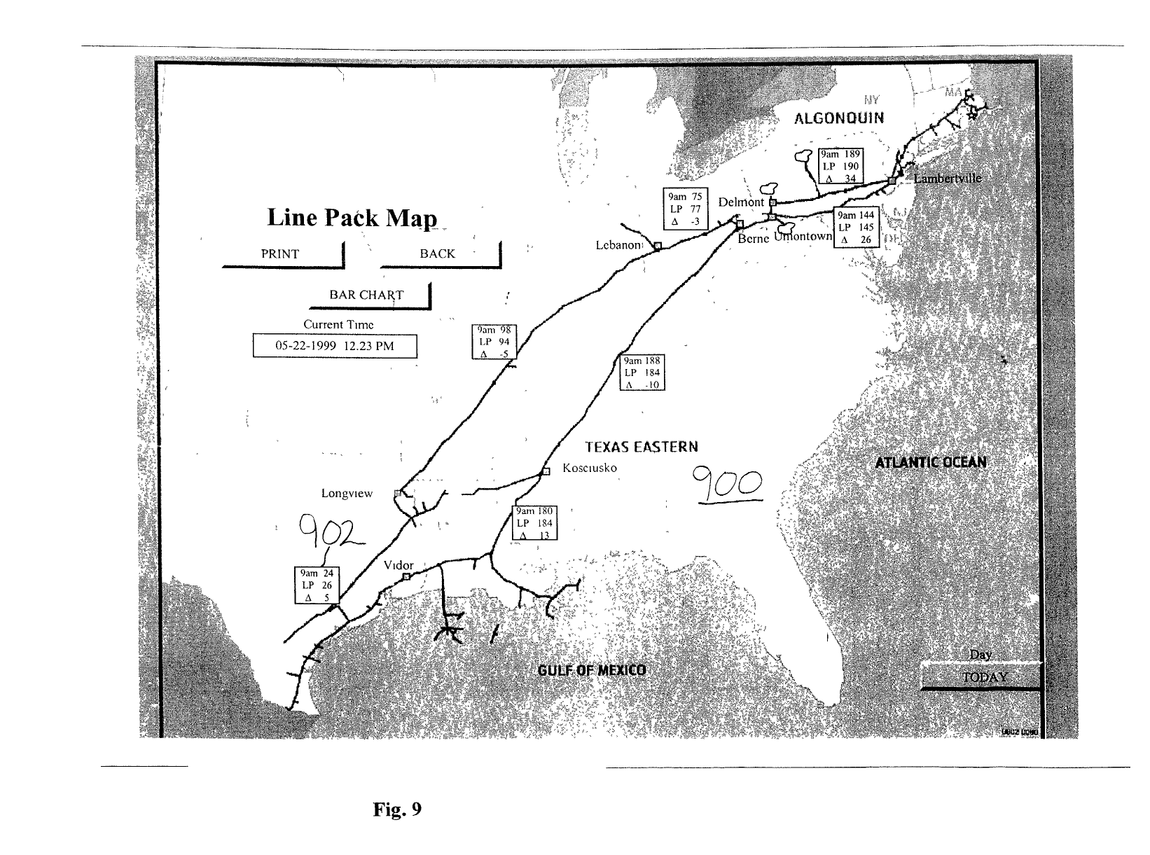

FIG. 9 depicts a screen that shows the “line pack” for a portion of a gas pipeline. The term “line pack” refers to the volume of natural gas in a given section of the pipeline. Screen 900 displays the current system line pack distribution and the amount that the individual section's line packs are expected to change over the remainder of the day given the operating plan currently in effect for the pipeline. Current line pack values are obtained from the SCADA systems and are contained in the operational information about the pipeline, while the expected line pack values are obtained from the modeling information. The current and expected line pack values are shown in boxes such as box 902 on screen 900. Box 902 shows the line pack value for 9:00 AM that day, the current line pack (designated on screen 900 as “LP”), and the predicted change in the line pack between the present time and the end of the day. This change in line pack value is derived by subtracting the current line pack value from the line pack for the same section at the end of the gas day, as computed by the modeling information. The values are shown in screen 900, and represent thousands of cubic feet of gas per day.

A user can also view line pack values for the next gas day and the predicted change in line pack values by clicking on the “DAY” button, located in the bottom, right-hand portion of screen 900. When the user elects to view tomorrow's line pack values, the central computer retrieves the line pack values for the beginning and end of the next day from the modeling information, and displays the line pack values for the beginning of the day and the anticipated changes in the line pack value between the beginning of the day and the end of the day.

The user can display the information shown in screen 900 in the form of a bar chart by clicking on the button labeled “BAR CHART” in the upper left portion of screen 900.

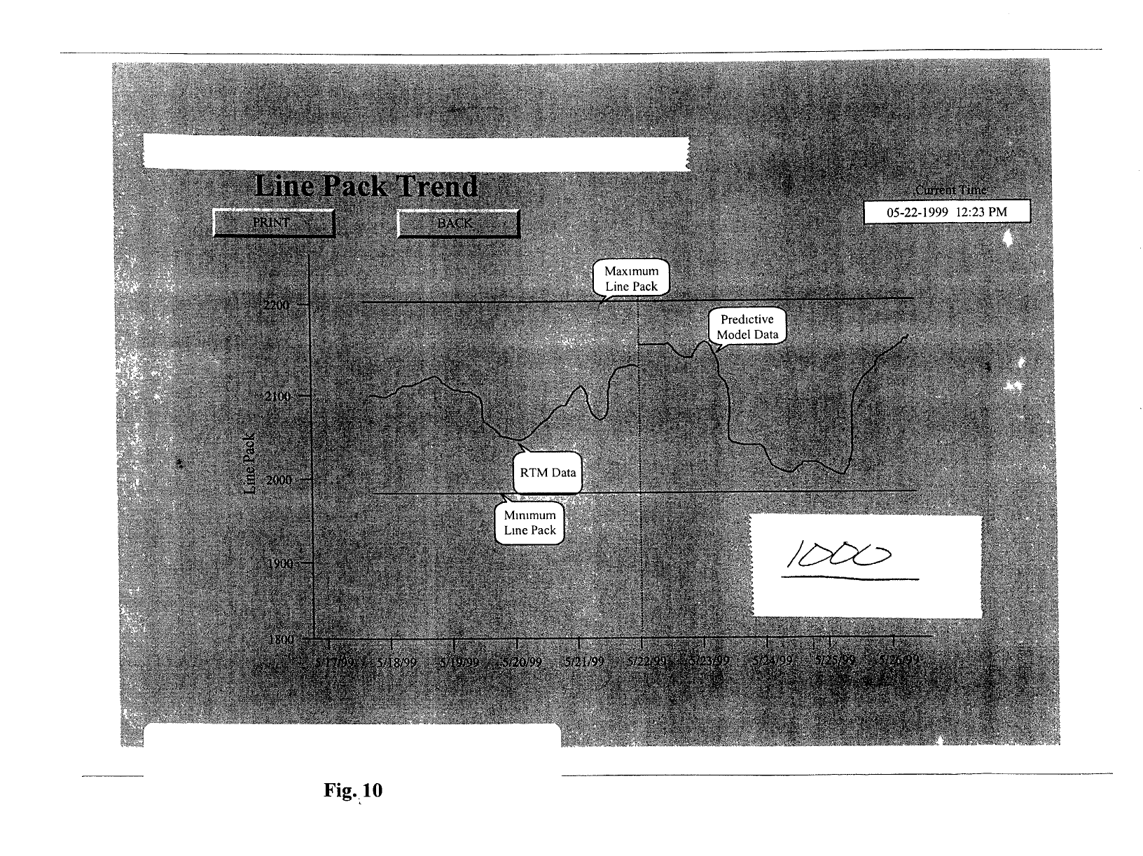

In the same manner described above with respect to screen 400, a user can view the trend of the line pack values for a segment of a pipeline by clicking on any of the line pack data boxes. Upon clicking on one of these boxes, a screen such as screen 1000 will appear. Screen 1000, illustrated in FIG. 10, shows the line pack values for a segment of the pipeline over a 10 day period. For the preceding five days, screen 1000 shows the line pack information as calculated by the SCADA and modeling systems. In addition, the predicted line pack information for the next five days is extracted from the modeling information. In addition, the maximum and minimum line pack information for that segment of the pipeline are displayed for the entire ten days. This information is obtained from the SCADA and modeling information provided to the database.

Finally, a user can view any specific segment of the pipeline in greater detail by clicking the mouse button while the cursor is located over the general area of interest. This manner of operation is the same as was described for screen 600. When a user chooses this option, the specific segment of the pipeline will be shown at a smaller scale, along with line pack information for additional locations along the segment of interest.

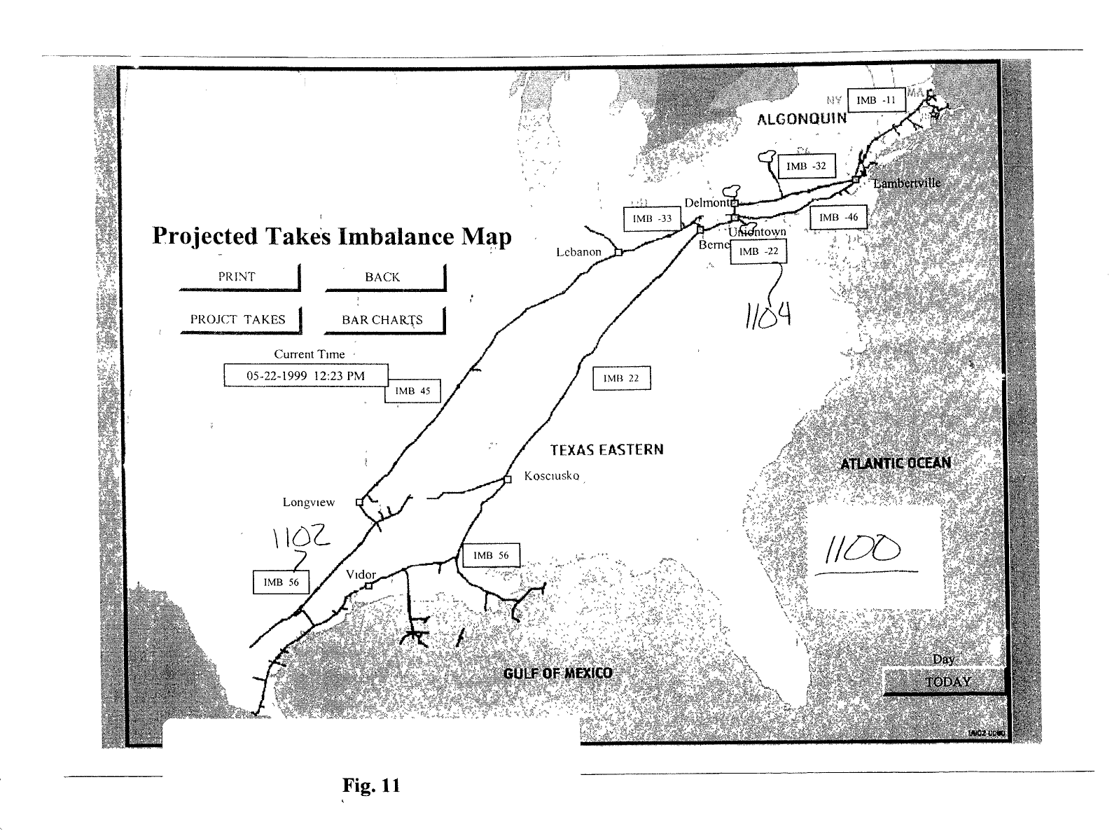

FIG. 11 illustrates a screen that shows where imbalances are occurring. An imbalance refers to the situation where a customer/supplier is withdrawing/supplying more gas from the pipeline than the customer was scheduled to take/supply. As shown in screen 1100, oversupplies are denoted as positive values in the data boxes, such as box 1102, while excessive withdrawals are shown as negative numbers, such as box 1104. The actual withdrawal/supply information is provided by SCADA measuring systems attached to the gas meters from which the gas is being withdrawn or supplied, while the scheduled withdrawal/supply information is obtained from the commercial information for the various locations.

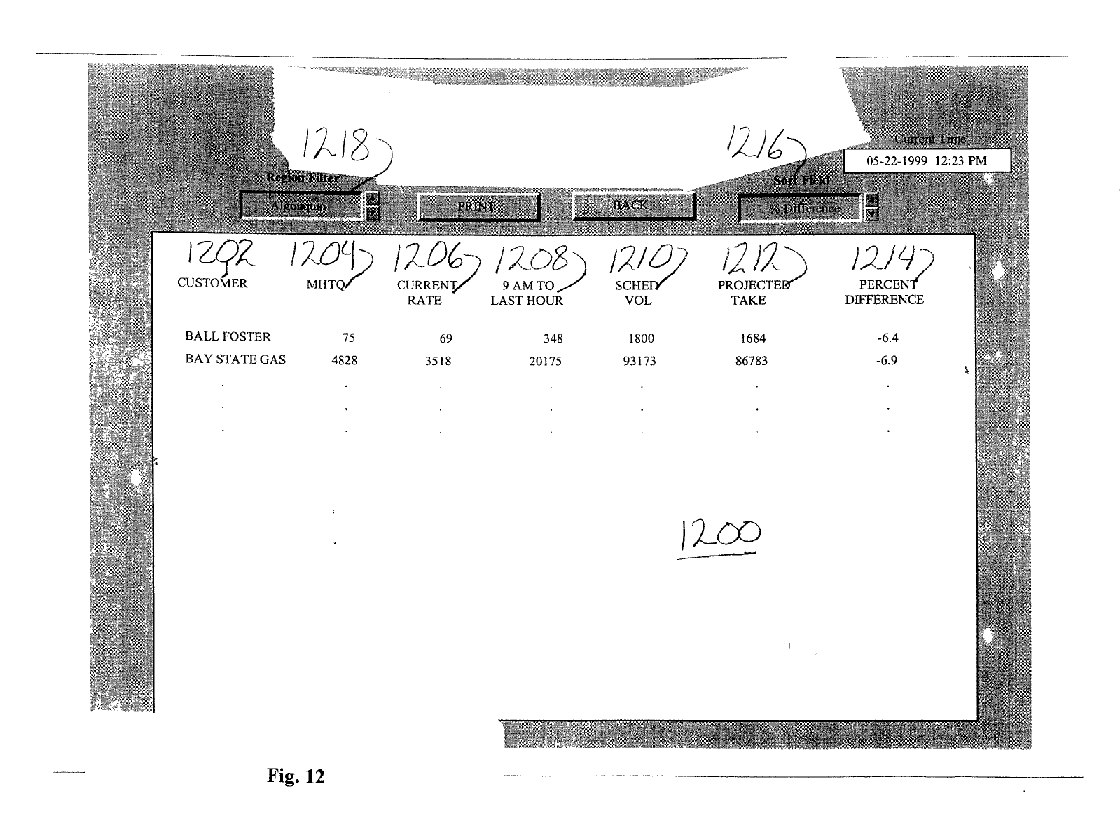

FIG. 12 shows a screen that displays information related to the information shown in screen 1100. Screen 1200 is a chart that depicts the projected takes by specific customers. As shown in screen 1200, column 1202 specifies the customers, column 1204 specifies the maximum amount of gas the customer is entitled to take in one hour, column 1206 shows the current rate at which a customer is withdrawing gas (in thousands of cubit feet of gas per day), column 1208 specifies the amount of gas the customer has withdrawn or delivered that day, since 9 A.M., column 1210 specifies the volume of gas the customer is entitled to take that day, column 1212 displays the actual projected take by the customer that day, as computed by the modeling systems, and column 1214 shows the percent difference between the amount of gas the customer is entitled to take, and the amount the customer is actually forecast to take. The information presented in columns 1206 and 1208 is obtained from the operational information about the pipeline, while the information presented in columns 1204 and 1210 is taken from commercial information concerning a specific customer.

Box 1218 allows data from different pipelines to be displayed and box 1216 gives the user the ability to control the display of information by sorting the information presented by any of the columns shown in screen 1200.

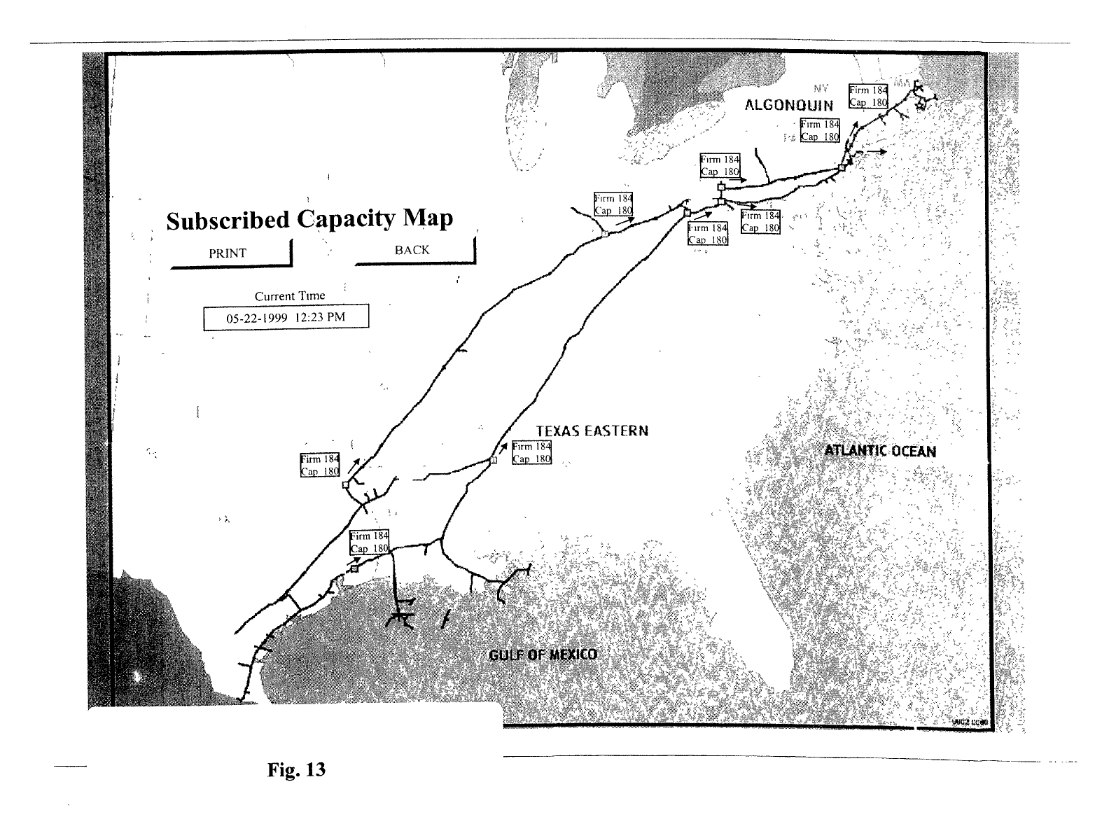

FIG. 13 illustrates a screen that shows the subscribed capacity of the pipeline. Screen 1300 shows how much gas has already been committed to be transported and the capacity of the pipeline. This information allows gas transmission companies to determine if they can commit to transport additional gas through the various segments of the pipeline. The information about the commitments to transport gas is obtained from the commercial information, while the capacity of the pipeline in a given location is determined from the modeling and operational information.

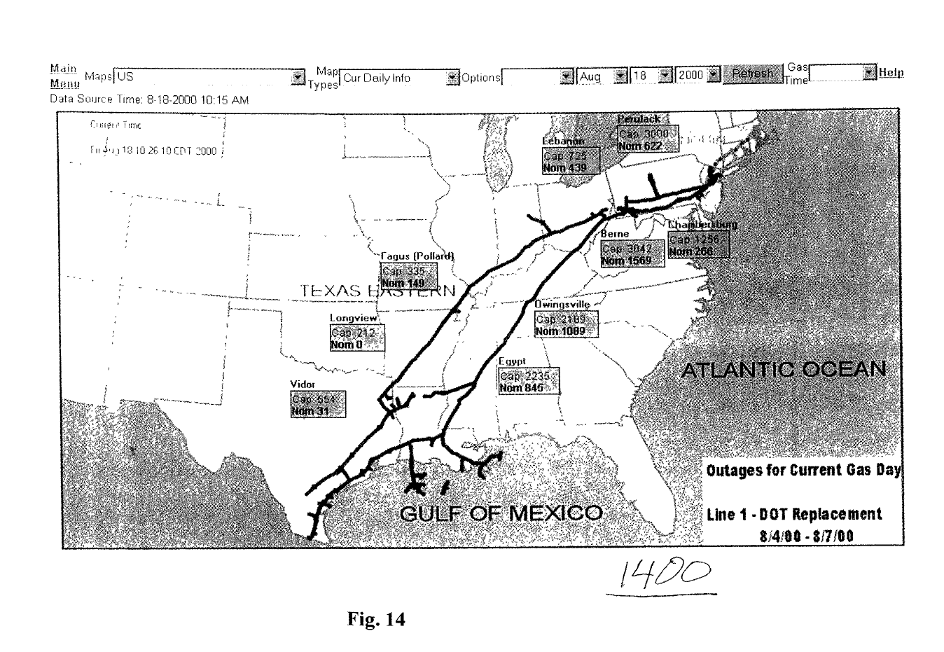

Screen 1400, shown in FIG. 14, depicts the capacity and nomination values for certain portions of the pipeline.

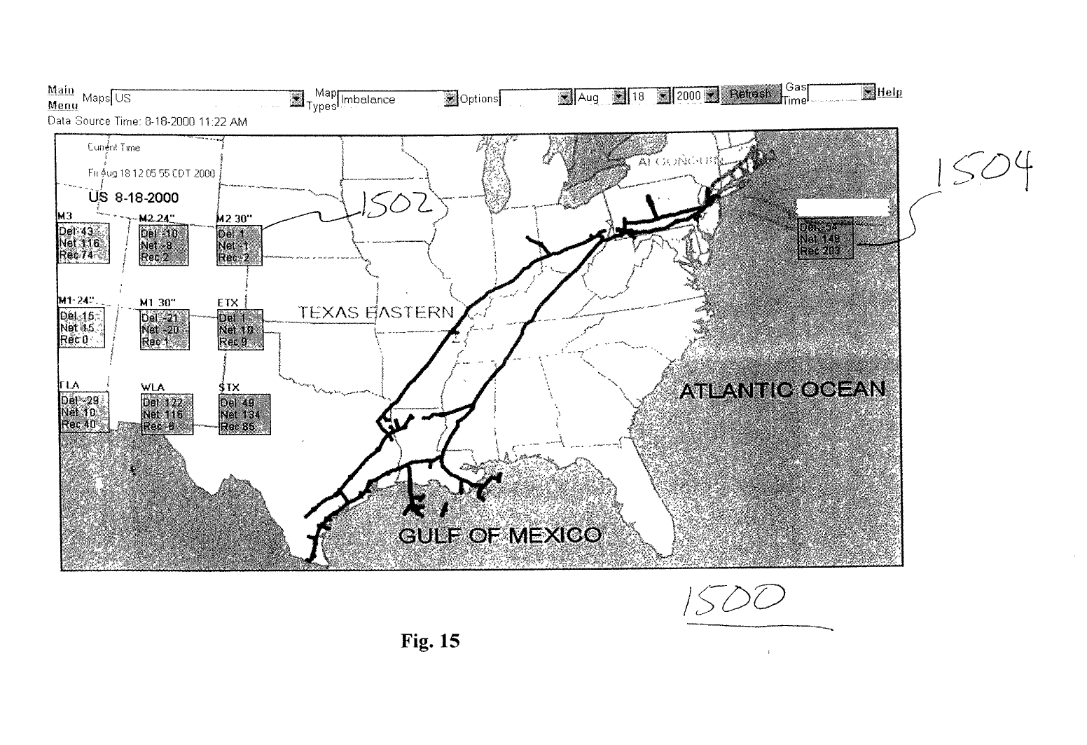

Screen 1500, shown in FIG. 15, displays imbalances for various sections of the pipeline. For example, box 1502 shows imbalances in the M2 30″ section of the pipeline. The first value in box 1502 is the delivery (“Del”) imbalance for the M2 30″ section of the line. This imbalance is determined by computing the difference between the deliveries as measured by the various physical meters in this section of the pipeline and the nominations associated with these meters. The receipt (“Rec”) imbalance represents the receipts imbalance for the particular section of the line. This value is the difference between the gas received by particular physical meters in that section of the line and the nominated receipt of gas associated with those meters. Finally, the net (“Net”) value represent the sum of the delivery and receipt imbalances. Thus, this sum represents the difference between the net gas withdrawn/delivered from the line and the net gas scheduled to be withdrawn/delivered from the line, with respect to the section of line indicated. Box 1504 contains the values discussed above for the entire system. The volumes shown in FIG. 15 are expressed in thousands of cubic feet of gas per day.

As indicated above, aspects of this invention pertain to specific “method functions” implementable through various computer systems. In an alternate embodiment, the invention may be implemented as a computer program product for use with a computer system. Those skilled in the art should readily appreciate that programs defining the functions of the present invention can be delivered to a computer in many forms, which include, but are not limited to: (a) information permanently stored on non-writeable storage media (e.g. read only memory devices within a computer such as ROMs or CD-ROM disks readable only by a computer I/O attachment); (b) information alterably stored on writeable storage media (e.g. floppy disks and hard drives); or (c) information conveyed to a computer through communication media, such as a local area network, a telephone network, or a public network like the Internet. It should be understood, therefore, that such media, when carrying computer readable instructions that direct the method functions of the present invention, represent alternate embodiments of the present invention.

While the invention has been particularly shown and described with reference to a preferred embodiment, it will be understood by those skilled in the art that various changes in form and detail may be made therein without departing from the spirit and scope of the invention.

1. A method for integrating and displaying information related to a natural gas pipeline using a computer system, comprising:
obtaining commercial, operational, and modeling information about the natural gas pipeline;
relating the commercial information to the operational information;
associating the commercial, operational, and modeling information with a location on a geographic representation of the natural gas pipeline; and
displaying a first particular item of information from the commercial, operational, and modeling information along with a geographic representation of the natural gas pipeline on the computer system.

2. The method described in claim 1, wherein the first particular item of information is a combination of two individual items of information selected from the commercial, operational, and modeling information.

3. The method described in claim 1, further comprising:
presenting several predefined combinations of the commercial information, operational information, and modeling information; and
receiving a selection of one of the several predefined combinations of the commercial information, operational information, and modeling information, wherein the selected predefined combination becomes the first particular item of information to be displayed.

4. The method described in claim 1, further comprising:
receiving a request to enlarge a portion of the geographic representation of the natural gas pipeline, wherein the first particular item of information is located in the portion to be enlarged;
obtaining additional items of commercial, operational, and modeling information for the geographic area to be enlarged; and
displaying the first particular item of information, the additional items of information, and an enlarged portion of the geographic representation of the natural gas pipeline.

5. The method described in claim 1, wherein the relating step further includes associating gas supplied to and withdrawn from the natural gas pipeline with the commercial information.

6. The method described in claim 1, wherein the relating step further includes utilizing the modeling information to associate future supplies of gas to and withdrawals of gas from the natural gas pipeline with the commercial information.

7. A method for integrating and displaying information related to a natural gas pipeline on a computer system, comprising:
inserting commercial, operational, and modeling information into a database structure;
receiving new commercial, operational, and modeling information;
updating the commercial, operational, and modeling information in the database with the new commercial, operational, and modeling information;
relating the commercial information to the operational information by determining which physical aspects of the natural gas pipeline correspond with particular components of commercial information; and
displaying a combination of the commercial, operational, and modeling information on the computer system.

8. The method described in claim 7, wherein the displaying step includes displaying commercial and operational data about a particular pipeline related data item up to present time, and displaying modeling information about forecast values for the particular pipeline data item into the future.

9. The method described in claim 7, wherein the relating step includes associating physical gas meters with nomination points.

10. The method described in claim 7, further comprising:
obtaining the operational information from a SCADA system associated with the natural gas pipeline; and
obtaining the modeling information from a computer modeling system that executes software to predict future supplies of gas to and withdrawals of gas from the natural gas pipeline.

11. An apparatus for integrating and displaying information related to a natural gas pipeline, comprising:
a computer system containing commercial, operational, and modeling information about the natural gas pipeline, the computer system being operable in a particular mode of operation, wherein the computer system
relates the commercial information to the operational information;
associates the commercial, operational, and modeling information with a location on a geographic representation of the natural gas pipeline; and
displays the first particular item of information from the commercial, operational, and modeling information along with a geographic representation of the natural gas pipeline.

12. The apparatus described in claim 11, wherein the first particular item of information is a combination of two individual items of information selected from the commercial, operational, and modeling information.

13. The apparatus described in claim 11, wherein the particular mode of operation further includes the computer system:
presenting several predefined combinations of the commercial information, operational information, and modeling information; and
receiving a selection of one of the several predefined combinations of the commercial information, operational information, and modeling information, wherein the selected predefined combination becomes the first particular item of information to be displayed.

14. The apparatus described in claim 11, wherein the particular mode of operation further includes the computer system:
receiving a request to enlarge a portion of the geographic representation of the natural gas pipeline, wherein the first particular item of information is located in the portion to be enlarged;
obtaining additional items of commercial, operational, and modeling information for the geographic area to be enlarged; and
displaying the first particular item of information, the additional items of information, and an enlarged portion of the geographic representation of the natural gas pipeline.

15. The apparatus described in claim 11, wherein the particular mode of operation further includes the computer system associating the supply of gas to and withdrawal of gas from the natural gas pipeline with the commercial information.

16. The apparatus described in claim 11, wherein the particular mode of operation further includes the computer system utilizing the modeling information to associate future gas supplies to and withdrawals from the natural gas pipeline with the commercial information.

17. An apparatus for integrating and displaying information related to a natural gas pipeline, comprising:
a computer system executing a database program that contains commercial, operational, and modeling information about the natural gas pipeline, the computer system being operable in a particular mode of operation, wherein the computer system
receives new commercial, operational, and modeling information;
updates the commercial, operational, and modeling information in the database with the new information;
relates the commercial information to the operational information by determining which physical aspects of the natural gas pipeline correspond with particular components of the commercial information; and
displays a combination of the commercial, operational, and modeling information.

18. The apparatus described in claim 17, wherein the particular mode of operation further includes the computer system displaying commercial and operational data about a particular pipeline related data item up to present time, and displaying modeling information about forecast values for the particular pipeline data item into the future.

19. The apparatus described in claim 17, wherein the particular mode of operation further includes the computer system associating physical gas meters with nomination points.

20. The apparatus described in claim 17, further comprising:
a SCADA system associated with the natural gas pipeline and connected to the computer system;
a computer modeling system that executes software which predicts the amount of gas to be supplied to and withdrawn from the natural gas pipeline; and
electronically transmitting the operational information and modeling information to a computer system in communication with the database.

21. An apparatus for integrating and displaying information related to a natural gas pipeline, comprising:
a computer system containing commercial, operational, and modeling information about the natural gas pipeline, wherein the computer system includes
relation means for relating the commercial information to the operational information;
association means for associating the commercial, operational, and modeling information with a location on a geographic representation of the natural gas pipeline; and
display means for displaying the first particular item of information from the commercial, operational, and modeling information along with a geographic representation of the natural gas pipeline.

22. The apparatus described in claim 21, wherein the first particular item of information is a combination of two individual items of information selected from the commercial, operational, and modeling information.

23. The apparatus described in claim 21, wherein the computer system further includes:
presentation means for presenting several predefined combinations of the commercial information, operational information, and modeling information; and
reception means for receiving a selection of one of the several predefined combinations of the commercial information, operational information, and modeling information, wherein the selected predefined combination becomes the first particular item of information to be displayed.

24. The apparatus described in claim 21, wherein the computer system further includes:
request reception means for receiving a request to enlarge a portion of the geographic representation of the natural gas pipeline, wherein the first particular item of information is located in the portion to be enlarged;
obtaining means for obtaining additional items of commercial, operational, and modeling information for the geographic area to be enlarged; and
display means for displaying the first particular item of information, the additional items of information, and an enlarged portion of the geographic representation of the natural gas pipeline.

25. The apparatus described in claim 21, wherein the computer system further includes association means for associating gas supplies to and withdrawals from the natural gas pipeline with the commercial information.

26. The apparatus described in claim 21, wherein the computer system further includes utilization means for utilizing the modeling information to associate future supplies of gas to and withdrawals of gas from the natural gas pipeline with the commercial information.

27. An apparatus for integrating and displaying information related to a natural gas pipeline, comprising:
a computer system executing a database program that contains commercial, operational, and modeling information about the natural gas pipeline, wherein the computer system further includes
reception means for receiving new commercial, operational, and modeling information;
update means for updating the commercial, operational, and modeling information in the database with the new information;
relation means for relating the commercial information to the operational information by determining which physical aspects of the natural gas pipeline correspond with particular components of commercial information; and
display means for displaying a combination of the commercial, operational, and modeling information.

28. The apparatus described in claim 27, wherein the computer system further includes display means for displaying commercial and operational data about a particular pipeline related data item up to present time, and displaying modeling information about forecast values for the particular pipeline data item into the future.

29. The apparatus described in claim 27, the computer system further includes association means for associating physical gas meters with nomination points.

30. The apparatus described in claim 27, further comprising:
a SCADA system for generating the operational information associated with the natural gas pipeline;
model means for generating the modeling information that predicts the amount of gas to be supplied to and withdrawn from the natural gas pipeline; and
transmission means for transmitting the operational information and modeling information to the database.
